(19) United States
(12) Patent Application Publication
(10) Pub. No.: US 2022/0336864 A1
(43) Pub. Date: Oct. 20, 2022

(54) AQUEOUS ELECTROCHEMICAL CELLS USING POLYMER GEL ELECTROLYTES

(71) Applicant: Urban Electric Power Inc., Pearl River, NY (US)

(72) Inventors: Jinchao HUANG, Pearl River, NY (US); Gautam YADAV, Pearl River, NY (US); Jungsang CHO, Pearl River, NY (US); Meir WEINER, Pearl River, NY (US); Aditya UPRETI, Pearl River, NY (US); Sanjoy BANERJEE, Pearl River, NY (US); Michael NYCE, Pearl River, NY (US)

(21) Appl. No.: 17/640,449

(22) PCT Filed: Sep. 3, 2020
(86) PCT No.: PCT/US2020/049098

§ 371 Date: Mar. 4, 2022

Related U.S. Application Data
(60) Provisional application No. 62/896,147, filed on Sep. 5, 2019.
(60) Provisional application No. 63/009,703, filed on Apr. 14, 2020.

(51) Int. Cl. H01M 10/36; H01M 4/24; H01M 4/32; H01M 4/34; H01M 4/62; H01M 50/44

(52) U.S. Cl. CPC H01M 10/36; H01M 4/244; H01M 4/32; H01M 4/34; H01M 4/628; H01M 50/44; H01M 2004/027

(57) ABSTRACT

A battery comprises an anode, a cathode, and a polymer electrolyte disposed between the anode and the cathode. The polymer electrolyte can include an inert hydrophilic polymer matrix impregnated with an aqueous electrolyte. The hydrophilic polymer matrix can include a polar vinyl monomer, an initiator, and a cross-linker. A gassing inhibitor can be included in the polymer electrolyte to help avoid issues with overcharging of the electrodes.

### CROSS-REFERENCE TO RELATED APPLICATIONS

This application claims the benefit of: 1) U.S. Provisional Application No. 62/896,147 filed on Sep. 5, 2019 and entitled “Polymer Gel Electrolyte and Its Use in Aqueous Electrochemical Cells,” 2) U.S. Provisional Application No. 63/009,703 filed on Apr. 14, 2020 and entitled “Protecting Zinc-Anode Batteries from Over Discharge Through Use of Polymer Gel Electrolytes,” both of which are incorporated herein by reference in their entirety for all purposes.

### STATEMENT REGARDING GOVERNMENTALLY SPONSORED RESEARCH OR DEVELOPMENT

This invention was made with Government support under Grant (or Contract) No. DE-SC0019913, awarded by the Department of Energy, Office of Electricity. The Government has certain rights in this invention.

### BACKGROUND

The alkaline battery is widely used because of its superior storage properties and high ionic conductivity compared to acidic or neutral electrolyte. However, these batteries are generally used only once and then discarded because of the inactivity of its raw materials. Also, the energy extracted from these batteries can become low through use because the nominal voltage at which the capacity is extracted is around 1.1 to 1.2V. These characteristics curtail the use of this cheap, safe, nonflammable, and environmentally chemistry to small scale applications. If the voltage of the battery can be increased, a high fraction of the theoretical capacity of the raw materials can be accessed reversibly many times. If the cost of the battery can still be kept low, then this would represent a significant improvement in the field of energy storage systems as it would open the use of manganese dioxide-zinc batteries for use in applications that can have a larger impact on human life like grid storage applications, home power backup, use in mobile electronics, etc.

### SUMMARY

In some embodiments, a battery comprises an anode, a cathode, and a polymer electrolyte disposed between the anode and the cathode. The polymer electrolyte comprise an inert hydrophilic polymer matrix impregnated with an aqueous electrolyte.

In some embodiments, a battery comprises an anode, a cathode, a catholyte in contact with the cathode and not the anode, and an anolyte disposed in contact with the anode and not the cathode, wherein the anolyte comprises an inert hydrophilic polymer matrix impregnated with an aqueous electrolyte.

In some embodiments, a method for fabricating a battery comprises forming a cathode, forming an anode comprising zinc, forming and disposing a gelled electrolyte between the anode and the cathode, and enclosing the cathode, the anode, and the gelled electrolyte to form a battery. The gelled electrolyte can comprise an inert hydrophilic polymer matrix impregnated with an aqueous electrolyte. In some embodiments, forming and disposing the gelled electrolyte between the anode and the cathode can include enclosing the anode and the cathode within a battery housing, injecting the aqueous electrolyte combined with a polymer monomer and initiator as a liquid into the battery housing, and polymerizing the aqueous electrolyte combined with the polymer monomer and initiator to form the gelled electrolyte within the battery housing.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a schematic representation of a battery according to an embodiment.

FIG. 2 illustrates a perspective view of a cylindrical battery according to an embodiment.

FIG. 3 illustrates another schematic representation of a battery according to an embodiment.

FIG. 4 illustrates still another schematic representation of a battery according to an embodiment.

FIG. 5 illustrates yet another schematic representation of a battery according to an embodiment.

FIG. 6A is a graph illustrating the charge and discharge capacity curves of a polymer electrolyte cell with sandwiched structure.

FIG. 6B is a graph illustrating the minimum/average discharge voltage curves of a polymer electrolyte cell with sandwiched structure.

FIG. 6C is a graph illustrating the coulombic/energy efficiency curves of a polymer electrolyte cell with sandwiched structure.

FIG. 7A is a graph illustrating the discharge capacity curves of three cells with different configurations.

FIG. 7B is a graph illustrating the minimum discharge voltage curves of three cells with different configurations.

FIG. 8A is a graph illustrating the cycling curves of a control cell and a polymer gel electrolyte cell both rated at 95 Ah capacity. The cells are cycling between 0 and 1.75V. The electrolyte concentrations in both the cells are 38 wt. %. The polymer gel electrolyte cell also has a gassing inhibitor.

FIG. 8B is a graph illustrating the charge and discharge capacity (Ah) fade of the 95 Ah polymer gel electrolyte cell with gassing inhibitor cycling between 0 and 1.75V.

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused. As used herein, a “catholyte” refers to an electrolyte solution in contact with the cathode without being in direct contact with the anode, and an “anolyte” refers to an electrolyte solution in contact with the anode without being in direct contact with the cathode. The term electrolyte alone can refer to the catholyte, the anolyte, or an electrolyte in direct contact with both the anode and the cathode.

The present disclosure provides methods for preparing an aqueous polymer gel electrolyte (PGE's) and methods for controlling the polymerization reaction by adjusting the electrolyte composition. Zinc-anode batteries containing cathodes like manganese dioxide (MnO₂) with liquid electrolyte in large scale systems can often be over discharged during system operation that lead to the cell failure due to formation of irreversible materials. Battery failure during these scenarios is due to the inherent dissolution chemistry of manganese dioxide and zinc. The use of PGE's can limit solubility of manganese and zinc ions and limit the extent of discharge in batteries even in over discharge conditions. The extent of utilization of manganese dioxide and zinc electrodes in PGE's can be carefully controlled by optimizing the reactant concentrations and temperatures, which we present in this disclosure. Methods for fabricating an electrochemical cell comprising electrodes and separators having imbibed therein the polymer gel electrolyte through in-situ polymerization are also described.

The Zn/MnO₂ battery has widespread applications due to its low cost, safety characteristics, and high theoretical energy density. However, the technology usually uses liquid aqueous alkaline electrolytes, which suffers from the problem of leakage of corrosive alkaline solutions and therefore are not suitable for integrating into portable devices. In order to prevent the leakage, the battery must be tightly sealed, which often brings additional problems in battery design and charge/discharge cycling performance. In order to develop a safe, reliable, leakproof Zn—MnO₂ battery and realize its full applications, replacing the aqueous liquid electrolytes with solid polymer electrolytes is of interest. Other advantages of using solid polymer electrolyte include its ability in restricting zincate ion migration and the possibility of application of different electrolytes for the cathode and the anode.

The primary interest of using polymer gel electrolyte's (PGE's) in zinc (Zn)-anode batteries with manganese dioxide (MnO₂) as the cathode is for its ability to prevent over discharging of batteries in large systems operation. In large system operations controlling the cycling profile of individual cells in batteries is challenging. Without the use of battery management systems this is a difficult if not an impossible task which can lead to overcharging or discharging of cells in batteries that affect their long-term performance. Overcharging or discharging of batteries can lead to gassing of electrolytes and formation of soluble species from electroactive cathodes and anodes that can lead to cell failure. Gassing of electrolytes prevent the complete sealing of cells. Gassing phenomena can somewhat be ascribed to electrochemical reactions taking place on electroactive materials beyond the electrochemical stability window of the electrolyte. PGE's can help mitigate these issues by reducing the solubility and water activity by fine tuning its polymeric structure. These PGE's can be synthesized with gassing inhibitors that coat on metallic anodes surface and prevent further gas formation. Furthermore, these PGE's can help limit the solubility of manganese and zinc ions, thus allowing control of the extent of electrochemical reactions taking place in the system. For example, the manganese dioxide soluble reactions take place in liquid electrolyte after 1V against zinc, which can lead to deleterious side reactions and formation of inactive substances. This can be disastrous in a large systems operation. With the use of PGE's, the solubility of manganese ions can be limited, and thus, reduce or eliminate the deleterious side reactions. Therefore, the battery could even be discharged to 0V and survive this operation as the soluble reactions are reduced or eliminated in the PGE's.

The polymer electrolyte can work as a bifunctional component in the battery, which combines the roles of electrolyte and separators. It enables the ionic conduction between the electrodes while working as a physical barrier to prevent the internal short circuit, thus greatly simplifying the battery design and improving its processability. Previous work on hydroxide conductive polymer electrolytes has focused on the development of solution-free polymer-salt complexes with alkaline salts incorporated into inert polymer matrix and single-phase alkaline anion exchange membranes (AAEM). However, the ionic conductivities of these polymer electrolytes are usually poor, which is far from meeting the requirements for real life battery applications. An alternative to the polymer-salt complex and the AAEM has been provided by polymer gel electrolytes as described herein. This type of polymer electrolyte usually contains an inert hydrophilic polymer matrix impregnated with aqueous alkaline electrolyte. It is similar with gelled electrolytes but in solid state. PGEs have an excellent electrolyte retaining ability, which facilitates the hydroxide conduction and results in a high ionic conductivity. Challenges for the polymer gel electrolyte are mainly the relatively poor mechanical properties, and more importantly, the limited interfacial area between the electrolyte and the electrode, which can lead to limited rate capability and reduced active material utilization. This is especially true when a porous electrode is used, where most of the pores cannot be accessed by the hydrogel film. Additionally, the passivation problem of the Zn electrode is aggravated due to the limited surface area and limited solubility. Being able to develop a mechanically/chemically stable polymer gel electrolyte with high hydroxide ion conductivity and a fabrication method of a polymer electrolyte cell with good electrode/electrolyte contact and electrolyte accessibility could provide remarkable advantages to or may even result in a complete redesign of the current alkaline Zn—MnO₂ batteries.

The present disclosure relates to the preparation of an aqueous polymer gel electrolyte for use in electrochemical cells, and methods for fabricating an electrochemical cell comprising electrodes, and optionally separators, having imbibed therein the polymer gel electrolyte through in-situ polymerization. The in-situ polymerization is realized by controlling the polymerization time through adjusting the electrolyte composition. Cells containing such electrolyte in either prismatic or cylindrical form can be provided.

In an embodiment, this disclosure features a method that includes selecting a monomer material for the polymer electrolyte. The monomer can be polar vinyl monomer selected from the group consisting of acrylic acid, vinyl acetate, acrylate esters, vinyl isocyanate, acrylonitrile, and any combinations thereof. In an embodiment, the disclosure features a method that includes selecting an aqueous electrolyte component for the polymer electrolyte. The aqueous electrolyte can be acid, base or neutral solutions. It may contain additives or can be used directly without any additives. The aqueous electrolyte for the cathode and anode can be identical or different. In an embodiment, the disclosure features a method that includes selecting a proper electrolyte composition to allow the polymerization reaction happen in-situ during soaking and allow sufficient time for the electrolyte to penetrate into the electrodes. In an embodiment, gassing inhibitors can be used that are mixed in with the electrolyte used in the polymerization process. Examples of gassing inhibitors include indium hydroxide, indium oxide, bismuth oxide, indium, bismuth, polyethylene glycol, cetyltrimethylammonium bromide, zinc oxide, polytetrafluoroethylene (e.g., PTFE that can also be referred to as Teflon), carboxymethyl cellulose, and combinations thereof. In an embodiment, the disclosure features a method that includes fabricating an electrode having imbibed therein the polymer electrolyte through in-situ polymerization. In an embodiment, the disclosure features a method for fabricating a solid-state battery containing electrodes impregnated with polymer gel electrolyte. In an embodiment, the disclosure features a method for fabricating a battery containing liquid electrolyte in the electrode and separator pores and solid polymer electrolyte in the voids of the battery containers.

In some embodiments, an alkaline battery with the ability to access its theoretical one electron (308 mAh/g) and/or its two electron (617 mAh/g) capacity is provided. The battery can use a single gelled electrolyte (e.g., a PGE), which may have a basic PH to form an alkaline battery. In some embodiments, dual electrolytes, at least one of which is gelled, can be present where the cathode is in acidic or near neutral electrolyte while the anode is in basic electrolyte. The batteries can be constructed in several different manners. In some embodiments, the cathode can have a liquid catholyte comprising of acidic or neutral solution, and the anode can be in contact with an anolyte that is a polymerized or gelled electrolyte. The use of a separator with this type of battery is optional, and in some embodiments, the separator is not present between the catholyte and the anolyte. In some embodiments, the battery can comprise a liquid catholyte and a polymerized or gelled anolyte with a separator disposed between the catholyte and anolyte. In some embodiments, both the catholyte and the anolyte can be polymerized or gelled, and a separator may not be placed between the catholyte and the anolyte. In still other embodiments, both the catholyte and the anolyte can be polymerized or gelled and a separator can be disposed between the catholyte and the anolyte. Each of these embodiments is described in more detail herein.

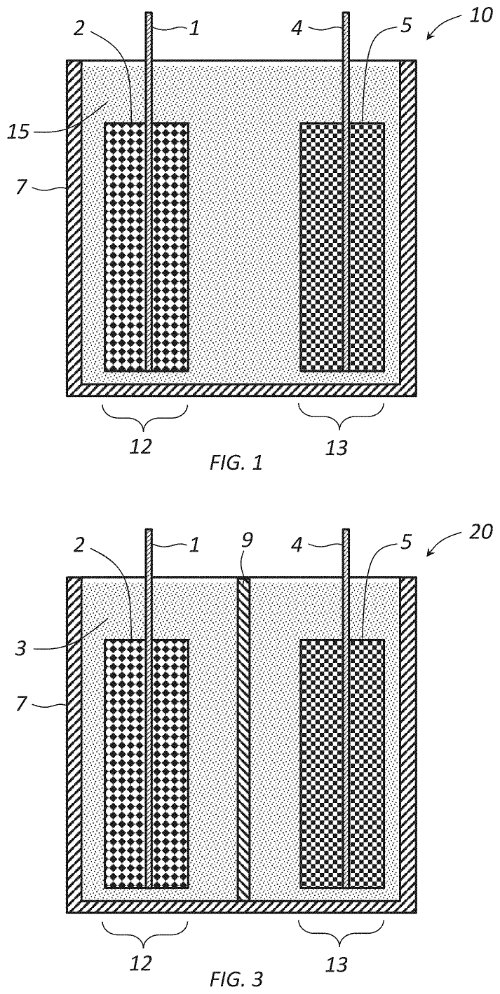

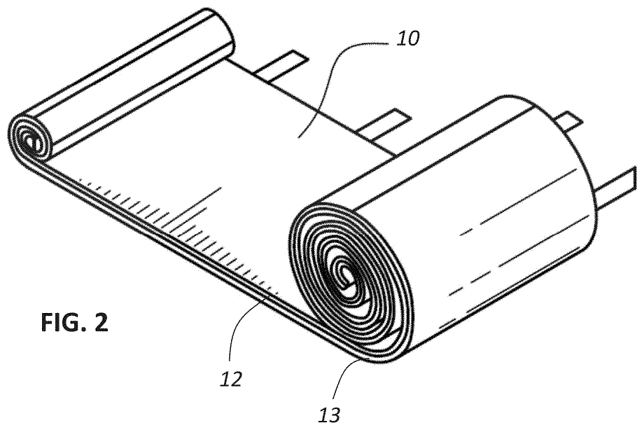

Referring to FIG. 1, a battery 10 can have a housing 7, a cathode 12, which can include a cathode current collector 1 and a cathode material 2, and an anode 13. In some embodiments, the anode 13 can comprise a anode current collector 4, and an anode material 5. It is noted that the scale of the components in FIG. 1 may not be exact as the features are illustrates to clearly show the electrolyte around the anode 13 and the cathode 12. FIG. 1 shows a prismatic battery arrangement having a single anode 13 and cathode 12. In another embodiment, the battery can be a cylindrical battery (e.g., as shown in FIG. 2) having the electrodes arranged concentrically or in a rolled configuration in which the anode and cathode are layered and then rolled to form a jelly roll configuration. The cathode current collector 1 and cathode material 2 are collectively called either the cathode 12 or the positive electrode 12, as shown in FIG. 2. Similarly, the anode material 5 with the optional anode current collector 4 can be collectively called either the anode 13 or the negative electrode 13. An electrolyte 15 can be in contact with the cathode 12 and the anode 13. As described in more detail herein, the electrolyte 15 in contact with both the cathode 12 and the anode can be the same, or alternatively, different electrolyte compositions can be used with the anode 13 and the cathode 12 to modify the properties of the battery 10 in some embodiments.

In some embodiments, the battery 10 can comprise one or more cathodes 12 and one or more anodes 13. When a plurality of anodes 13 and/or a plurality of cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jellyroll configuration, the battery 10 may only have one cathode 12 and one anode 13 in a rolled configuration such that a cross section of the battery 10 includes a layered configuration of alternating electrodes, though a plurality of cathodes 12 and anodes 13 can be used in a layered configuration and rolled to form the rolled configuration with alternating layers.

In an embodiment, housing 7 comprises a molded box or container that is generally non-reactive with respect to the electrolyte solutions in the battery 10, including the electrolyte 15. In an embodiment, the housing 7 comprises a polypropylene molded box, an acrylic polymer molded box, or the like.

The cathode 12 can comprise a mixture of components including an electrochemically active material. Additional components such as a binder, a conductive material, and/or one or more additional components can also be optionally included that can serve to improve the lifespan, rechargeability, and electrochemical properties of the cathode 12. The cathode 12 can comprise a cathode material 2 (e.g., an electroactive material, additives, etc.). Suitable cathode materials 2 can include, but are not limited to, manganese dioxide, copper manganese oxide, hausmannite, manganese oxide, copper intercalated bismuth birnessite, birnessite, todokorite, ramsdellite, pyrolusite, pyrochroite, nickel oxyhydroxide, a silver oxide, or any combination thereof. In some embodiments, the cathode can comprise an air electrode.

In some embodiments, the cathode material 2 can be based on one or many polymorphs of MnO₂, including electrolytic (EMD), α-MnO₂, β-MnO₂, γ-MnO₂, δ-MnO₂, ε-MnO₂, or λ-MnO₂. Other forms of MnO₂ can also be present such as pyrolusite, birnessite, ramsdellite, hollandite, romanechite, todorkite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄), CuMn₂O₄, zinc manganese dioxide, or any combination thereof. In general the cycled form of manganese dioxide in the cathode can have a layered configuration, which in some embodiment can comprise 6-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

The addition of a conductive additive such as conductive carbon enables high loadings of an electroactive material in the cathode material, resulting in high volumetric and gravimetric energy density. The conductive additive can be present in a concentration between about 1-30 wt %. In some embodiments, the conductive additive can comprise graphite, carbon fiber, carbon black, acetylene black, single walled carbon nanotubes, multi-walled carbon nanotubes, nickel or copper coated carbon nanotubes, dispersions of single walled carbon nanotubes, dispersions of multi-walled carbon nanotubes, graphene, graphyne, graphene oxide, or a combination thereof. Higher loadings of the electroactive material in the cathode are, in some embodiments, desirable to increase the energy density. Other examples of conductive carbon include TIMIREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), Zenyatta graphite, and/or combinations thereof.

In some embodiments, the conductive additive can have a particle size range from about 1 to about 50 microns, or between about 2 and about 30 microns, or between about 5 and about 15 microns. The total conductive additive mass percentage in the cathode material 2 can range from about 5% to about 99% or between about 10% to about 80%. In some embodiments, the electroactive component in the cathode material 2 can be between 1 and 99 wt. % of the weight of the cathode material 2, and the conductive additive can be between 1 and 99 wt. %. The cathode material 2 can also comprise a conductive component. The addition of a conductive component such as metal additives to the cathode material 2 may be accomplished by addition of one or more metal powders such as nickel powder to the cathode material 2. The conductive metal component can be present in a concentration of between about 0-30 wt % in the cathode material 2. The conductive metal component may be, for example, nickel, copper, silver, gold, tin, cobalt, antimony, brass, bronze, aluminum, calcium, iron, or platinum. In one embodiment, the conductive metal component is a powder. In some embodiments, the conductive component can be added as an oxide and/or salt. For example, the conductive component can be cobalt oxide, cobalt hydroxide, lead oxide, lead hydroxide, or a combination thereof. In some embodiments, a second conductive metal component is added to act as a supportive conductive backbone for the first and second electron reactions to take place. The second electron reaction has a dissolution-precipitation reaction where Mn³⁺ ions become soluble in the electrolyte and precipitate out on the materials such as graphite resulting in an electrochemical reaction and the formation of manganese hydroxide [Mn(OH)₂] which is non-conductive. This ultimately results in a capacity fade in subsequent cycles. Suitable conductive components that can help to reduce the solubility of the manganese ions include transition metals like Ni, Co, Fe, Ti and metals like Ag, Au, Al, Ca. Oxides and salts of such metals are also suitable. Transition metals like Co can also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% conductive component (e.g., a conductive metal), and 1-10% binder.

In some embodiments, a binder can be used with the cathode material 2. The binder can be present in a concentration of between about 0-10 wt %. In some embodiments, the binder comprises water-soluble cellulose-based hydrogels, which can be used as thickeners and strong binders, and have been cross-linked with good mechanical strength and with conductive polymers. The binder may also be a cellulose film sold as cellophane. The binders can be made by physically cross-linking the water-soluble cellulose-based hydrogels with a polymer through repeated cooling and thawing cycles. In some embodiments, the binder can comprise a 0-10 wt. % carboxymethyl cellulose (CMC) solution cross-linked with 0-10 wt. % polyvinyl alcohol (PVA) on an equal volume basis. The binder, compared to the traditionally-used PTFE, shows superior performance. PTFE is a very resistive material, but its use in the industry has been widespread due to its good rollable properties. This, however, does not rule out using PTFE as a binder. Mixtures of PTFE with the aqueous binder and some conductive carbon can be used to create rollable binders. Using the aqueous-based binder can help in achieving a significant fraction of the two electron capacity with minimal capacity loss over many cycles. In some embodiments, the binder can be water-based, have superior water retention capabilities, adhesion properties, and help to maintain the conductivity relative to an identical cathode using a PTFE binder instead. Examples of suitable water based hydrogels can include, but are not limited to, methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), and combinations thereof. Examples of crosslinking polymers include polyvinyl alcohol, polyvinylacetate, polyaniline, polyvinylpyrrolidone, polyvinylidene fluoride, polypyrrole, and combinations thereof. In some embodiments, a 0-10 wt % solution of water-cased cellulose hydrogen can be cross linked with a 0-10% wt solution of crosslinking polymers by, for example, repeated freeze/thaw cycles, radiation treatment, and/or chemical agents (e.g. epichlorohydrin). The aqueous binder may be mixed with 0-5% PTFE to improve manufacturability.

The cathode material 2 can also comprise additional elements. The additional elements can be included in the cathode material including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). The bismuth compound can be present in the cathode material at a concentration between about 1-20 wt % of the weight of the cathode material 2. Examples of bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth, and/or combinations thereof.

The copper compound can be incorporated into the cathode 12 as an organic or inorganic salt of copper (oxidation states 1, 2, 3, or 4), as a copper oxide, or as copper metal (i.e., elemental copper). The copper compound can be present in a concentration between about 1-70 wt % of the weight of the cathode material 2. In some embodiments, the copper compound is present in a concentration between about 5-50 wt % of the weight of the cathode material 2. In other embodiments, the copper compound is present in a concentration between about 10-50 wt % of the weight of the cathode material 2. In yet other embodiments, the copper compound is present in a concentration between about 5-20 wt % of the weight of the cathode material 2. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full reversibility during galvanostatic cycling, as compared to a bismuth-modified MnO₂ which cannot withstand galvanostatic cycling as well.

The cathodes 12 can be produced using methods implementable in large-scale manufacturing. For a MnO₂ cathode, the cathode 12 can be capable of delivering the full second electron capacity of the MnO₂. In some embodiments, the cathode material 2 can comprises 2-30% wt conductive carbon, 0-30% conductive metal additive, 1-70% wt. copper compound, 1-20% wt bismuth compound, 0-10 wt % binder and birnessite or EMD. In another embodiment the cathode material comprises 2-30 wt % conductive carbon, 0-30% conductive metal additive, 1-20% wt bismuth compound, 0-10 wt % binder and birnessite or EMD. In one embodiment, the cathode material consists essentially of 2-30 wt % conductive carbon, 0-30% conductive metal additive, 1-70% wt. copper compound, 1-20 wt % bismuth compound, 0-10% wt binder and the balance birnessite or EMD. In another embodiment the cathode material consists essentially of 2-30 wt % conductive carbon, 0-30% conductive metal additive, 1-20% wt bismuth compound, 0-10 wt % binder and the balance birnessite or EMD.

The resulting cathode may have a porosity in the range of 20%-85% as determined by mercury infiltration porosimetry. The porosity can be measured according to ASTM D4284-12 “Standard Test Method for Determining Pore Volume Distribution of Catalysts and Catalyst Carriers by Mercury Intrusion Porosimetry” using the version as of the date of the filing of this application.

The cathode material 2 can be formed on a cathode current collector 1 formed from a conductive material that serves as an electrical connection between the cathode material and an external electrical connection or connections. In some embodiments, the cathode current collector 1 can be, for example, carbon, lead, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, bismuth, titanium, half nickel and half copper, or any combination thereof. In some embodiments, the current collector 1 can comprise a carbon felt or conductive polymer mesh. The cathode current collector may be formed into a mesh (e.g., an expanded mesh, woven mesh, etc.), perforated metal, foam, foil, felt, fibrous, porous block architecture, perforated foil, wire screen, a wrapped assembly, or any combination thereof. In some embodiments, the current collector can be formed into or form a part of a pocket assembly, where the pocket can hold the cathode material 2 within the current collector 1. A tab (e.g., a portion of the cathode current collector 1 extending outside of the cathode material 2 as shown at the top of the cathode 12 in FIG. 1) can be coupled to the current collector to provide an electrical connection between an external source and the current collector.

The cathode material 2 can be pressed onto the cathode current collector 1 to form the cathode 12. For example, the cathode material 2 can be adhered to the cathode current collector 1 by pressing at, for example, a pressure between 1,000 psi and 20,000 psi (between 6.9×10⁶ and 1.4×10⁸ Pascals). The cathode material 2 may be adhered to the cathode current collector 1 as a paste. The resulting cathode 12 can have a thickness of between about 0.1 mm to about 5 mm.

In some embodiments, the anode material 5 can comprise zinc, which can be present as elemental zinc and/or zine oxide. In some embodiments, the Zn anode mixture comprises Zn, zinc oxide (ZnO), an electronically conductive material, and a binder. The Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material. Additional elements that can be in the anode in addition to the zinc or in place of the zinc include, but are not limited to, lithium, aluminum, magnesium, iron, cadmium and a combination thereof, where each element can be present in amounts that are the same or similar to that of the zinc described herein.

In some embodiments, the anode material 5 can comprise zinc oxide (ZnO), which may be present in an amount of from about 5 wt. % to about 20 wt. %, alternatively from about 5 wt. % to about 15 wt. %, or alternatively from about 5 wt. % to about 10 wt. %, based on the total weight of anode material. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In an embodiment, an electrically conductive material may be optionally present in the anode material in an amount of from about 5 wt. % to about 20 wt. %, alternatively from about 5 wt. % to about 15 wt. %, or alternatively from about 5 wt. % to about 10 wt. %, based on the total weight of the anode material. As will be appreciated by one of skill in the art, and with the help of this disclosure, the electrically conductive material can be used in the Zn anode mixture as a conducting agent, e.g., to enhance the overall electric conductivity of the Zn anode mixture. Non-limiting examples of electrically conductive material suitable for use can include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive material can also comprise any of the conductive carbon materials described with respect to the cathode material including, but not limited to, acetylene black, single walled carbon nanotubes, multi-walled carbon nanotubes, graphene, graphyne, or any combinations thereof

The anode material 5 may also comprise a binder. Generally, a binder functions to hold the electroactive material particles (e.g., Zn used in anode, etc.) together and in contact with the current collector. The binder can be present in a concentration of 0-10 wt %. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be PTFE, which is a very resistive material, but its use in the industry has been widespread due to its good rollable properties. In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material.

In some embodiments, the anode material 5 can be used by itself without a separate anode current collector 4, though a tab or other electrical connection can still be provided to the anode material 5. In this embodiment, the anode material may have the form or architecture of a foil, a mesh, a perforated layer, a foam, a felt, or a powder. For example, the anode can comprise a Zn metal foil electrode, a Zn mesh electrode, or a perforated Zn metal foil electrode.

In some embodiments, the anode 13 can comprise an optional anode current collector 4. The anode current collector 4 can be used with an anode 13, including any of those described with respect to the cathode 12. The anode material 5 can be pressed onto the anode current collector 4 to form the anode 13. For example, the anode material 5 can be adhered to the anode current collector 4 by pressing at, for example, a pressure between 1,000 psi and 20,000 psi (between 6.9×10⁶ and 1.4×10⁸ Pascals). The anode material 5 may be adhered to the anode current collector 4 as a paste. A tab of the anode current collector 4, when present, can extend outside of the device to form the current collector tab. The resulting anode 13 can have a thickness of between about 0.1 mm to about 5 mm.

The battery 10 can comprise an electrolyte 15 that can be gelled to form a semi-solid polymerized electrolyte 15 (e.g., a PGE). In some embodiments, the electrolyte can be an alkaline electrolyte. The alkaline electrolyte can be a hydroxide such as potassium hydroxide, sodium hydroxide, lithium hydroxide, ammonium hydroxide, cesium hydroxide, or any combination thereof. The resulting electrolyte 15 can have a pH greater than 7, for example between 7 and 15.1. In some embodiments, the pH of the electrolyte can be greater than or equal to 10 and less than or equal to about 15.13.

In addition to a hydroxide, the electrolyte can comprise additional components. In some embodiments, the alkaline electrolyte can have zinc oxide, potassium carbonate, potassium iodide, and/or potassium fluoride as additives. When zinc compounds are present in the electrolyte, the electrolyte can comprise zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, sodium hydroxide, potassium hydroxide, lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, acrylic acid, N,N′-Methylenebisacrylamide, potassium persulfate, ammonium persulfate, sodium persulfate, or a combination thereof.

In some embodiments, the electrolyte can be an aqueous solution having an acidic or neutral pH. When the electrolyte is acid, the electrolyte can comprise an acid such as a mineral acid (e.g., hydrochloric acid, nitric acid, sulfuric acid, etc.). In some embodiments, the catholyte solution can comprise a solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, zinc sulfate, zinc triflate, zinc acetate, zinc nitrate, bismuth chloride, bismuth nitrate, nitric acid, sulfuric acid, hydrochloric acid, sodium sulfate, potassium sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium sulfate, lithium bromate, or any combination thereof. In some embodiments, the electrolyte can be an acidic or neutral solution, and the pH of the electrolyte can be between 0 and 7.

In some embodiments, the electrolyte can comprise a gassing inhibitor that can coat on metallic anodes surface and reduce or prevent gas formation. In an embodiment, gassing inhibitors can be used that are mixed in with the electrolyte used in the polymerization process. Suitable gassing inhibitors can include, but are not limited to, indium hydroxide, indium, indium oxide, bismuth oxide, bismuth, carboxymethyl cellulose, polyethylene glycol, zinc oxide, cetyltrimethylammonium bromide, polytetrafluoroethylene, and combinations thereof. In some embodiments, the gassing inhibitor can be present in the electrolyte in an amount in a range of 0.05 to about 7 mg/ml, or between about 0.1 to about 5 mg/ml.

As described herein, the electrolyte can be polymerized or gelled to form a PGE. The resulting anolyte can be in a semi-solid state that resists flowing within the battery. For example, the polymer gel electrolyte can comprise an inert hydrophilic polymer matrix impregnated with aqueous electrolyte. The electrolyte can be polymerized using any suitable techniques. In an embodiment, a method of forming a PGE can begin with selecting a monomer material for the PGE. The monomer can be polar vinyl monomer selected from the group consisting of acrylic acid, vinyl acetate, acrylate esters, vinyl isocyanate, acrylonitrile, or any combinations thereof. The aqueous electrolyte component can then be selected, and can include any of the components described above with respect to the electrolyte. An initiator can be added to start the polymerization process. In some embodiments, a cross-linker can be used in the electrolyte composition to further cross-link the polymer matrix in order to form the PGE. The monomer in the composition (e.g., a polar vinyl monomer) can be present in an amount of between about 5% to about 50% by weight, the initiator can be present in an amount of between about 0.001 wt. % to about 0.1 wt. %, and the cross-linker can be present in an amount of between 0 to 5 wt. %.

In some embodiments, the PGE can be formed in-situ, which refers to the introduction of the electrolyte as a liquid into the housing followed by subsequent polymerization to form the PGE within the housing. This method can allow the electrolyte composition to soak into the void spaces, the anode, and the cathode prior to fully polymerizing to form the PGE. In some embodiments, a vacuum (e.g., a pressure less than atmospheric pressure) can be created within the housing 7 upon introduction of the electrolyte 15. The vacuum can serve to remove air and allow the electrolyte 15 to penetrate the anode 13, the cathode 12, and/or the various void spaces within the battery 10. In some embodiments, the vacuum can be between about 10 and 29.9 inches of mercury or between about 20 and about 29.9 inches of mercury vacuum. The use of the vacuum can help to avoid the presence of air pockets within the battery 10 prior to the full polymerization of the electrolyte. In some embodiments, the electrodes can be soaked in the electrolyte solution for between 1-120 minutes at a temperature of between 0° C. to 30° C. prior to full polymerization of the electrolyte to allow the electrolyte to impregnate the electrodes. Once the electrolyte is polymerized, the battery can be allowed to rest prior to use. In some embodiments, the battery can be allowed to rest for between 5 minutes and 24 hours.

In order to help impregnate the electrodes with the electrolyte, the electrodes can be pre-soaked with the electrolyte solution prior to polymerizing the electrolyte. This can be performed by soaking the electrodes in the electrolyte (or in a catholyte or anolyte separately as described in more detail herein) outside of the battery or housing, and then placing the pre-soaked electrodes into the housing to construct the battery. In some embodiments, an electrolyte that does not contain a polymer or gelling agent can be introduced into the battery to soak the electrodes in-situ. This can include the use of a vacuum to assist in impregnating the electrodes. The electrodes can be soaked for between about 1 minute and 24 hours. In some embodiments, the soaking can be carried out over a plurality of cycles in which the battery is filled with the electrolyte and allowed to soak, drained, refilled and allowed to soak, followed by draining a desired number of times. Once the electrodes are soaked and impregnated with the electrolyte, the electrolyte containing the polymer and polymerization agents (e.g., an initiator, cross-linking agent, etc.) can be introduced into the housing and allowed to polymerize to form the final battery.

The composition of the electrolyte, the monomer material, the initiator, and the conditions of the formation (e.g., temperature, etc.) can be selected to provide a desired polymerization time to allow the electrolyte composition to properly soak the components of the batter to absorb and penetrate into the electrodes. The temperature can be controlled to control the polymerization process, where colder temperatures can inhibit or slow the polymerization, and warmer temperatures can decrease the polymerization time or accelerate the polymerization process. In addition, an increase in an alkaline electrolyte component (e.g., a hydroxide) can decrease the polymerization time, and an increase in the initiator concentration will decrease the polymerization time. Suitable polymerization times can be between 1 minute and 24 hours, based on the composition of the electrolyte solution and the temperature of the reaction.

As an example of a polymerization process, a mixture of acrylic acid, N, N′-methylenebisacrylamide, and alkaline solution can be created at a temperature of around 0° C. Any additives can then be added to the solution (e.g., gassing inhibitors, additional additives as described herein, etc.). For example, zinc oxide, when used in the electrolyte, can be dissolved in the alkaline solution after mixing the precursor components, where the zinc oxide can beneficial during the electrochemical cycling of the anode. To polymerize the resulting mixture an initiator such as potassium persulfate can be added to initiate the polymerization process and form a solid or semi-solid polymerized electrolyte (e.g., a PGE). The resulting polymerized electrolyte can be stable over time once the polymerization process has occurred.

The polymerization process can occur prior to the construction of the battery 10 or after the cell is constructed. In some embodiments, the electrolyte can be polymerized and placed into a tray to form a sheet. Once polymerized, the sheet can be cut into a suitable size and shape and one or more layers can be used to form the electrolyte 15 in contact with the anode 13. When a pre-formed PGE is used, additional liquid electrolyte can be introduced into the battery and/or the electrodes can be pre-soaked with the electrolyte prior to constructing the battery.

As shown in FIG. 1, the battery 10 may not comprise a separator. The ability to form the battery 10 without a separator may allow for the overall cost of the battery to be reduced while having the same or similar performance to a battery with a separator. The use of the PGE can serve the function of the separator by forming a physical barrier between the anode 13 and the cathode 12 to prevent short circuiting.

In some embodiments, a separator can be disposed between the anode 13 and the cathode 12 when the electrodes are constructed into the battery. FIG. 3 illustrates an embodiment of a battery 20 that is similar to the battery 10 with the exception that the battery 20 can have a separator 9 disposed between the cathode 12 and the anode 13. The remaining portions of the battery 20 can be the same as those described with respect to the battery 10 of FIG. 1. While shown as being disposed between the anode 13 and the cathode 12, the separator 9 can be used to wrap one or more of the anode 13 and/or the cathode 12, or alternatively one or more anodes 13 and/or cathodes 12 when multiple anodes 13 and cathodes 12 are present.

The separator 9 may comprise one or more layers. For example, when the separator is used, between 1 to 5 layers of the separator can be applied between adjacent electrodes. The separator can be formed from a suitable material such as nylon, polyester, polyethylene, polypropylene, poly(tetrafluoroethylene) (PTFE), poly(vinyl chloride) (PVC), polyvinyl alcohol, cellulose, or any combination thereof. Suitable layers and separator forms can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. In some embodiments, the separator 9 can comprise a CELGARD® brand microporous separator. In an embodiment, the separator 9 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, or a combination thereof.

While the separator 9 can comprise a variety of materials, the use of a PGE for the electrolyte 15 can allow for a relatively inexpensive separator 9 to be used when one or more separators are present. For example, the separator 9 can comprise CELLOPHANE®, polyvinyl alcohol, CELGARD®, a composite of polyvinyl alcohol and graphene oxide, crosslinked polyvinyl alcohol, PELLON®, and/or a composite of carbon-polyvinyl alcohol. Use of the separator 9 may help in improving the cycle life of the battery 20, but is not necessary in all embodiments.

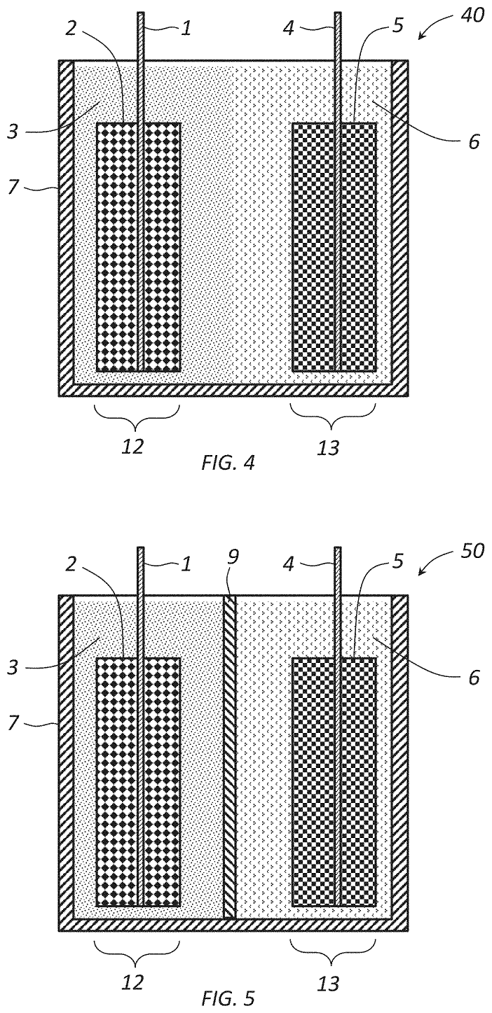

In some embodiments, separate electrolytes can be used with the cathode 12 and the anode 13. As shown in FIG. 4, a catholyte 3 can be in contact with the cathode 12, and an anolyte 6 can be in contact with the anode 13. As described in more detail herein, the catholyte 3 and/or the anolyte 6 can be polymerized or gelled to form separate PGEs to prevent mixing between the two electrolyte solutions. In some embodiments, the anolyte can be polymerized or gelled as described herein with respect to the electrolyte 15 of FIG. 1, and the catholyte 3 can be a liquid. The anolyte can comprise any of the compositions as described with respect to the electrolyte herein, including comprising a gassing inhibitor. The polymerization of the anolyte can prevent mixing between the catholyte and the anolyte even when the catholyte is a liquid. The catholyte and the anolyte can have the same compositions or different compositions. When the compositions are the same, the catholyte and the anolyte can have an alkaline pH and comprise any of the compositions as described herein with respect to the electrolyte of FIGS. 1-3.

As shown in FIG. 4, a battery 40 can comprise a polymerized or gelled catholyte 3 and a polymerized or gelled anolyte 6 without a separator disposed between the catholyte 3 and the anolyte 6. The remaining portions of the battery 40 can be the same or similar to those described with respect to the battery 10 in FIG. 1, and like parts will not be redescribed in the sake of brevity.

When a separate catholyte is present, the catholyte can be in direct contact with the cathode 12 but not the anode. In some embodiments, the catholyte can comprise an acid such as a mineral acid (e.g., hydrochloric acid, nitric acid, sulfuric acid, etc.). In some embodiments, the catholyte solution can comprise a solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, zinc sulfate, zinc triflate, zinc acetate, zinc nitrate, bismuth chloride, bismuth nitrate, nitric acid, sulfuric acid, hydrochloric acid, sodium sulfate, potassium sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium sulfate, lithium bromate, or any combination thereof. For example, the catholyte solution can comprise manganese sulfate mixed with sulfuric acid or potassium permanganate mixed with sulfuric acid. Other dopants to this solution can be zinc sulfate, lead sulfate, titanium disulfide, titanium sulfate hydrate, silver sulfate, cobalt sulfate, nickel sulfate, or any combination thereof. The catholyte can be an acidic or neutral solution, and the pH of the catholyte can be between 0 and 7. The catholyte can be used in conditions having temperatures ranging between 0 and 200° C.

In some embodiments, the catholyte can comprise a permanganate. Permanganates have a high positive potential. This can allow the overall cell potential to be increased within the battery 10. When present, the permanganate can be present in a molar ratio of an acid (e.g., a mineral acid such a hydrochloric acid, sulfuric acid, etc.) to permanganate of between about 1:1 to about 1:6, or between about 1:2 to about 1:4, or about 1:3, though the exact amount can vary based on the expected operation conditions of the battery 10. The concentration of the permanganate (e.g., potassium permanganate or a salt of permanganate, etc.) can be greater than 0 and less than or equal to 5 M. In some embodiments, the catholyte solution comprises sulfuric acid, hydrochloric acid or nitric acid at a concentration greater than 0 and less than or equal to 4M. The catholyte can also comprise a gassing inhibitor, including any of those described herein for use with the electrolyte.

The catholyte as described above can be polymerized to form a gelled electrolyte that can resist movement and mixing with the anolyte 6 using the materials and process as described with respect to the electrolyte. The catholyte 3 can be polymerized using any suitable polymerization techniques for an acidic or neutral solution. As an example, the catholyte 3 can be polymerized by mixing the acidic or neutral solution with polyvinyl alcohol (PVA) to create a hydrogel. This gelled structure can be further treated with two to three thaw cycles, where the acidic-PVA hydrogel structure can be cooled to a temperature between −20° C. to 0° C. and then brought back to room temperature repeatedly. To improve the properties of the acidic hydrogel, a quinone-based compound like p-benzenediol and alizarin red S can be added to the mixture of PVA, acidic, or neural solution before the thaw steps. Any other suitable polymerization or gelling techniques or processes can also be used. Once gelled, the catholyte 3 and the anolyte 6 can be placed in contact within the housing 7 and used within the battery 40.

FIG. 5 illustrates another embodiment of a battery 50 in which a polymerized or gelled catholyte 3 and a polymerized or gelled anolyte 6 can be separated by a separator 9. The remaining portions of the battery 50 can be the same or similar to those described with respect to the battery 10 in FIG. 1 and the battery 40 with respect to FIG. 4, and like parts will not be redescribed in the sake of brevity. As shown in FIG. 5, the separator 9 can be placed between the gelled catholyte 3 and the gelled anolyte 6. The separator 9 can comprise any of the separators described with respect to the separator 9 in FIG. 3. The use of the separator 9 in the battery 50 may serve to improve the cycle life of the battery 50.

Once constructed, the batteries according to any of the embodiments herein can be used as primary or secondary batteries. When used as secondary batteries, the resulting batteries can be cycled at 100% of 308 mAh/g and 50-100% of 617 mAh/g, though lower depth of discharge (DOD) can also be used. Within the cycling, the batteries can be discharged and then recharged using various charging protocols. The resulting secondary batteries can be cycled for hundreds of cycles with stable performance. During use, the use of the PGE as a single electrolyte or the use of gelled catholytes and anolytes can serve to limit the solubility of manganese and zinc ions and limit the extent of discharge in batteries even in over discharged conditions.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

A hydroxide conductive polymer electrolyte was prepared from a mixed solution of acrylic acid and potassium hydroxide (KOH). N,N′methylene-bisacrylamide (MBA) was used as the cross-linker and potassium persulfate (K₂S₂O₈) was used to initiate the polymerization reaction. The polymerization of polyacrylate mainly proceeds through a free radical polymerization mechanism. The reaction rate and the properties of the formed poly(acrylate-KOH—H₂O) hydrogel electrolyte are both affected by the polymerization conditions, including the temperature and the solution composition, i.e. the concentrations of the monomer, the crosslinker, the initiator and the KOH solution. In order to slow down the polymerization reaction kinetics, different concentrations of the initiator and KOH were tested, which was summarized in Table 1. It is noticed that by reducing the initiator concentration, the time needed for the electrolyte to gel is increased while increasing the KOH concentration accelerates the polymerization reaction.

TABLE 1

| | Exp. 1 | Exp. 2 | Exp. 3 | Exp. 4 | Exp. 5 | Exp. 6 | Exp. 7 |
|---|---|---|---|---|---|---|---|
| MBA (wt %) | 0.06 | | | | | | |
| AA (wt %) | 14.04 | | | 13.12 | | | |
| KOH (wt %) | 29.87 | | | 38.84 | | | |
| H₂O (wt %) | 55.99 | | | 47.94 | | | |
| K₂S₂O₈% (wt %) | 0.02 | 0.01 | 0.005 | 0.0036 | 0.0024 | 0.0020 | 0.0014 |
| Gelation time at room | 3 | 30 | 60 | 20 | 30 | 34 | N/A |
| temperature (min) | | | | | | | |

### Example 2

A hydroxide conductive polymer hydrogel film was prepared from a mixed solution of acrylic acid and potassium hydroxide (KOH). The concentration of KOH was 30 wt % and the K₂S₂O₈ initiator concentration was 0.02%. A 0.5 mm thick hydrogel film was fabricated by pouring the mixed solution onto a PTFE substrate and drying at room temperature. This resulting film is a freestanding rubber-like film that is dimensionally stable.

A small-scale prismatic Zn—MnO₂ cell was prepared by sandwiching the hydrogel film in between the cathode and the anode. No extra separator was used. The electrode size was 1″ by 1.35″. The Zn anode used was a porous pasted electrode. The MnO₂ cathode was an electrode pasted from the mixture of EMD (electrolytic γ-MnO₂) particles, graphite and PTFE binder. A galvanostatic cycling test of this cell was carried out to evaluate the polymer electrolyte performance. The Zn—MnO₂ cell was charged with constant current at C/20 to 1.65 V (C is the 1st electron capacity of MnO₂), followed with a constant-voltage (CV) taper charging. Then a constant-current (C/20) discharge process was followed till the cutoff voltage of 1.0 V.

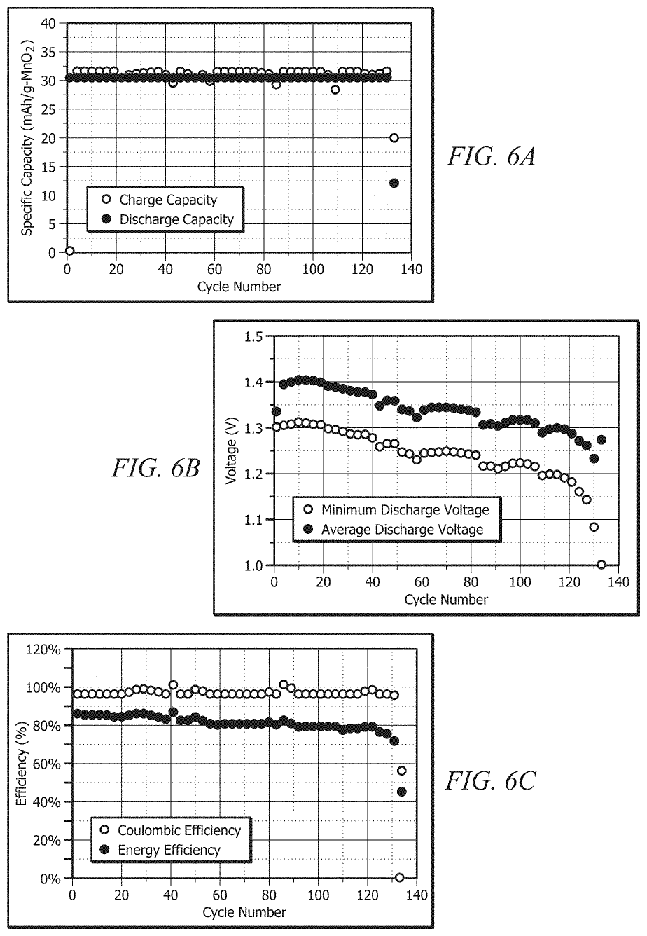

FIGS. 6A-6C shows the cycling performance of a Zn—MnO₂ cell with the above polymer gel electrolyte and illustrate the charge and discharge capacity (FIG. 6A), the minimum discharge voltage and average discharge voltage (FIG. 6B), and the coulombic efficiency and energy efficiency (FIG. 6C). The cell was cycling at a depth of discharge (DOD) of 10% of the MnO₂ 1-electron capacity. It is found that with the utilization of polymer electrolyte, the Zn—MnO₂ was able to achieve more than 130 cycles stably before the discharge minimum voltage reached 1.0 V. It exhibited a good nominal voltage above 1.3 V and a high energy efficiency above 80%.

### Example 3

Large-scale prismatic cells of 8.69″ height, 3.44″ width and 1.85″ thickness containing multiple 3″ by 6″ electrodes were fabricated. Each cell contained 10 anodes and 9 cathodes. Three layers of cellophane and one layer of pellon were used as the separator in between each pair of adjacent electrodes. The nameplate capacity of each cell was 95 Ah. Three cells of the same construction except for the electrolyte were tested. The control cell was a regular cell filled with 25 wt % liquid KOH solution. The polymer electrolyte cell #1 was first filled with liquid KOH solution (25 wt %) and soaked for 12 hours. The electrolyte was then completely drained after soaking and the poly(acrylate-KOH—H₂O) solution was filled in before being gelled. The polymer electrolyte cell #2 was directly filled with the poly(acrylate-KOH—H₂O) solution and allowed the polymerization reaction to happen in-situ during soaking. In both polymer electrolyte cells, the combination of 38.84% KOH and 0.002% initiator was used.

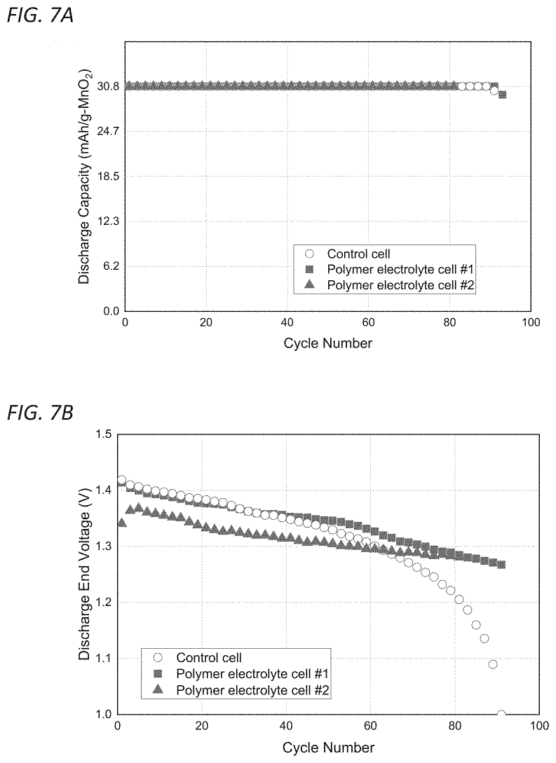

Cycle life tests were carried out by running cells at 10% depth of discharge (DOD) (9.5 Ah). A constant current charging and discharging protocol was adopted. The top voltage for charging was set at 1.75 V, and the cutoff discharge voltage was set at 1.0 V. A rate of C/40 was used for both charging and discharging. The cycling performances of three cells were compared in FIGS. 7A and 7B. FIG. 7A shows the capacity change as a function of cycle number. All cells achieved the desired capacity (30.8 mAh/g-MnO₂, i.e. 10% DOD of MnO₂ 1-electron capacity) for the first 90 cycles. FIG. 7B compares the minimum voltage of each cell. The minimum discharge voltage is normally the cell voltage at the end of discharge (i.e., DEV). The change of DEV is usually used as an indicator of the cell's condition. It can be seen that while the polymer electrolyte cell #2 started with a lower DEV, which is probably due to the higher impedance caused by the completely gelled electrolyte, its long-term cycling performance surpassed the others. Polymer electrolyte cell #1 started with a high DEV similar with the control cell due to the pre-soaking, and still stayed above 1.25V for almost 100 cycles. The control cell, however, showed the worst performance as the DEV hit the cutoff voltage limit at 1.0V starting from the 90th cycle and capacity fade started to occur. The proposed hypothesis for such a quick failure is a short circuit caused by zinc dendrites.

### Example 4

Large-scale prismatic cells of 8.69″ height, 3.44″ width and 1.85″ thickness containing multiple 3″ by 6″ electrodes were fabricated. Each cell contained 10 anodes and 9 cathodes. Three layers of cellophane and one layer of pellon were used as the separator in between of each electrode. The nameplate capacity of each cell was 95 Ah. Two cells of the same construction except for the electrolyte were tested. The control cell was a regular cell filled with 38 wt % liquid KOH solution. The second cell was filled with polymer gel electrolyte with gassing inhibitors.

The process for forming the polymer gel electrolyte with gassing inhibitors is the same as mentioned in example 1 except for the addition of indium hydroxide (in an amount of 0.025 mg/ml) as the gassing inhibitor in the potassium hydroxide before the polymerization step. The reaction conditions and the steps involved in creating the hydrogel before the free radical polymerization route are the same as presented in example 1.

The polyacrylate hydrogel with indium hydroxide in it was chilled to 0° C. Before filling the cell with the hydrogel, 0.002% initiator was added to chilled solution. The polymerization is highly dependent on temperature of the solution and as long as the solution is chilled the polymerization will not start immediately. This chilled solution was immediately vacuum filled into the 95 Ah cell immersed in an ice bath at least 2 times to ensure that the cell had soaked up the polymeric solution. After vacuuming, the cell was allowed to reach room temperature and allowed to polymerize. The starting KOH concentration used for the polymerization was 45 wt. %, which after the polymerization ended up being near 38 wt. %.

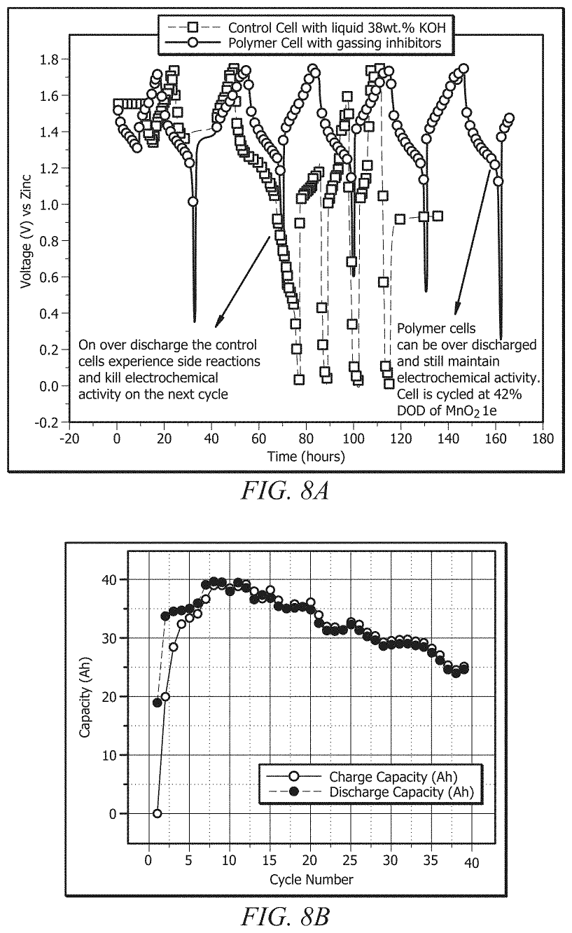

The main objective in this example was to understand the over discharge protection characteristics of the polymer gel electrolyte cell. The control cell was at first cycled at 20% DOD of its rated capacity (95 Ah) for two cycles. For these two cycles the top of charge was capped off to 1.75V and the end of discharge was capped off to 1V. A constant charge and discharge protocol was followed at C/20 of one electron capacity. On the third cycle the cell was over discharged to 0V to understand its effect on cycling behavior in subsequent cycles. From FIG. 8A, it is very clear that on over discharge the control cell is not able to cycle efficiently. The dissolution-precipitation reactions of manganese dioxide after 1V are seen which indicate to deleterious side reactions that kill the electrochemical activity of the cell. The very next cycle most of the electrochemical activity >1V is lost in the control cell indicating its failure.

In comparison, the polymer gel electrolyte cell with indium hydroxide gassing inhibitor was cycled from the first cycle between 0 and 1.75V at constant current charge and discharge at C/20 of the first electron. From FIG. 8A, the rechargeable characteristics of this cell are clearly seen with high electrochemical activity >1V for every cycle. The polymer gel electrolyte prevents any solution-based side reactions after 1V, which allows for the cell to be recharged back without any negative effects seen. The cell operates on proton insertion mechanism from the first electron region. This cell is able to discharge at ˜42% DOD of the one electron capacity of MnO₂ and >16% DOD of the two electron capacity of Zn.

The capacity fade characteristics of the polymer gel electrolyte cell are also shown in FIG. 8B. This cell exhibits very minimal fade and still retains its cycling behavior at high DOD's on the MnO₂ and Zn electrodes. The coulombic efficiency is ˜100% with the energy efficiency being ˜80%.

This cycling behavior is useful in a number of consumer-related operations as usually a consumer does not know the extent of discharge that he/she has performed on the cell. This removes the need for creating battery management systems with overcharge and discharge protections as the deleterious electrochemical activity related to cell failure can now be curtailed by the design of smart polymers.

Having described various batteries, systems, and methods, specific aspects can include, but are not limited to:

In a first aspect, a battery comprises: an anode; a cathode; a polymer anolyte; a polymer catholyte; and a separator disposed between the anode and the cathode.

A second aspect can include the battery of the first aspect, wherein the anode comprises a pasted porous Zn electrode, a Zn metal foil electrode, a Zn mesh electrode, or a perforated Zn metal foil electrode.

A third aspect can include the battery of the first or second aspect, wherein the cathode comprises a manganese dioxide electrode, a nickel oxyhydroxide electrode, a silver oxide electrode, or an air electrode.

A fourth aspect can include the battery of any one of the first to third aspects, wherein the separator comprises films fabricated from nylon, polyester, polyethylene, polypropylene, poly(tetrafluoroethylene) (PTFE), poly(vinyl chloride) (PVC), polyvinyl alcohol, cellulose, or combinations thereof.

A fifth aspect can include the battery of any one of the first to fourth aspects, wherein the polymer anolyte and catholyte comprise an inert hydrophilic polymer matrix impregnated with aqueous electrolyte.

A sixth aspect can include the battery of the fifth aspect, wherein the polymer matrix comprises a polar vinyl monomer, an initiator and a cross-linker.

A seventh aspect can include the battery of the sixth aspect, wherein the polar vinyl monomer is selected from the group consisting of acrylic acid, vinyl acetate, acrylate esters, vinyl isocyanate, acrylonitrile, and any combinations thereof.

An eighth aspect can include the battery of the sixth or seventh aspect, wherein the polar vinyl monomer is present in the amount of 5% to 50%, the initiator is present in the amount of 0.001% to 0.1%, and the cross-linker in the amount of 0 to 5%.

A ninth aspect can include the battery of any one of the first to eighth aspects, wherein the aqueous electrolyte comprises a base solution and additives.

A tenth aspect can include the battery of the ninth aspect, wherein the base solution comprises sodium hydroxide, potassium hydroxide, lithium hydroxide, ammonium hydroxide, or any combinations thereof.

An eleventh aspect can include the battery of the ninth or tenth aspect, wherein the pH of the solution is in the range from 7.0 to 15.1.

A twelfth aspect can include the battery of the fifth aspect, wherein the aqueous electrolyte is acid, base, or neutral solution containing additives.

A thirteenth aspect can include the battery of the twelfth aspect, wherein the aqueous electrolyte has a pH in the range from 0 to 15.1.

A fourteenth aspect can include the battery of any one of the first to thirteenth aspects, wherein the anolyte and the catholyte can be identical or can be different electrolytes.

A fifteenth aspect can include the battery of the first aspect and any of the aqueous electrolytes of the ninth, twelfth, or fourteenth aspects, wherein the anolyte and catholyte can contain gas inhibitors like indium hydroxide, indium, indium oxide, bismuth oxide, bismuth, carboxymethyl cellulose, polyethylene glycol, zinc oxide, cetyltrimethylammonium bromide, and combinations thereof.

A sixteenth aspect can include the battery of any one of the first to fifteenth aspects, wherein the polymerization reaction of the anolyte and the catholyte can be controlled through adjusting the electrolyte composition and the polymerization completion time can be 1 minute to 24 hours.

In a seventeenth aspect, a method for fabricating an electrode having imbibed therein the polymer gel electrolyte as defined in the fifth aspect through in-situ polymerization.

An eighteenth aspect can include the method of the seventeenth aspect, wherein the electrode is a porous electrode or a nonporous electrode containing active materials, inactive additives, binders and current collector.

A nineteenth aspect can include the method of the seventeenth or eighteenth aspect, wherein the electrode is immersed in the electrolyte solution at temperature between 0° C. to 30° C. for 0 to 120 minutes before the electrolyte gets completely polymerized, to allow impregnation of electrolyte into the electrode.

A twentieth aspect can include the method of any one of the seventeenth to nineteenth aspects, wherein the electrode is further allowed to rest for 0 to 24 hours at a temperature between 0° C. to 30° C. after soaking to let the polymerization reaction complete in-situ.

A twenty first aspect can include the method of the twentieth aspect, wherein the electrolyte impregnated electrode has a thickness between 0.1 mm to 5 mm.

In a twenty second aspect, a method for fabricating a battery as described in the first aspect containing polymer electrolyte impregnated electrodes fabricated through a method as described in the seventeenth aspect.

A twenty third aspect can include the method of the twenty second aspect, wherein the battery can be prismatic or cylindrical.

A twenty fourth aspect can include the battery of the twenty third aspect, wherein the prismatic configuration is fabricated by first pairing an anolyte impregnated anode and a catholyte impregnated cathode and then stacking one pair or multiple pairs of electrodes together.

A twenty fifth aspect can include the battery of the twenty third aspect, wherein the cylindrical configuration is fabricated by first laminating an anolyte impregnated anode with a catholyte impregnated cathode and then winding the electrodes into a jellyroll.

A twenty sixth aspect can include the battery of any one of the twenty third to twenty fifth aspects, wherein 0 to 5 layers of separator can be applied between each electrode.

In a twenty seventh aspect, a method for fabricating a battery as defined in the first aspect containing electrodes impregnated with the polymer electrolyte as defined in the fifth aspect through vacuum filling and in-situ polymerization.

A twenty eighth aspect can include the method of the twenty seventh aspect, wherein the battery is a prismatic or cylindrical battery pre-assembled in dry state containing dry electrodes and separators without electrolyte.

A twenty ninth aspect can include the method of the twenty seventh or twenty eighth aspect, wherein the electrolyte goes into the cell in liquid state after all the electrolyte components are mixed and before the electrolyte getting polymerized.

A thirtieth aspect can include the method of any one of the twenty seventh to twenty ninth aspects, wherein the battery is filled by first pulling 20 to 29.9 inches of mercury vacuum in the cell and then having the electrolyte injected in.

A thirty first aspect can include the method of any one of the twenty seventh to thirtieth aspects, wherein the battery is allowed to rest for 0 to 24 hours before testing to let the polymerization reaction complete.

In a thirty second aspect, a method for fabricating a battery as defined in the first aspect containing electrodes impregnated with liquid electrolyte and with polymer electrolyte filling up the voids in the battery container.

A thirty third aspect can include the method of the thirty second aspect, wherein the liquid electrolyte is aqueous acid, base or neutral solution with or without additives.

A thirty fourth aspect can include the method of the thirty second or thirty third aspect, wherein the battery is a prismatic or cylindrical battery pre-assembled in dry state containing dry electrodes and separators without electrolyte.

A thirty fifth aspect can include the method of any one of the thirty second to thirty fourth aspects, wherein the battery is filled by first pulling 20 to 29.9 inches of mercury vacuum in the cell and then having the liquid electrolyte injected in. The battery is then drained to remove any extra liquid electrolyte after soaking.

A thirty sixth aspect can include the method of the thirty fifth aspect, wherein the drained battery is then filled with polymer electrolyte as defined in claim 5.

A thirty seventh embodiment can include the method of the thirty sixth aspect, wherein the battery is allowed to rest for 0 to 24 hours before testing to let the polymerization reaction complete.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A battery comprising:
an anode;
a cathode; and
a polymer electrolyte disposed between the anode and the cathode, wherein the polymer electrolyte comprise an inert hydrophilic polymer matrix impregnated with an aqueous electrolyte.

2. The battery of claim 1, wherein the hydrophilic polymer matrix comprises a polar vinyl monomer, an initiator, and a cross-linker.

3. The battery of claim 2, wherein the polar vinyl monomer is selected from the group consisting of: acrylic acid, vinyl acetate, acrylate esters, vinyl isocyanate, acrylonitrile, and combinations thereof.

4. The battery of claim 2, wherein the polar vinyl monomer is present in the amount in a range of 5 wt. % to 50 wt. %, the initiator is present in the amount in a range of 0.001 wt. % to 0.1 wt. %, and the cross-linker is present in an amount in a range of 0.001 wt. % to 5 wt. %.

5. The battery of claim 1, wherein the aqueous electrolyte comprises a basic solution and additives, and wherein the base solution comprises sodium hydroxide, potassium hydroxide, lithium hydroxide, ammonium hydroxide or any combination thereof.

6. (canceled)

7. (canceled)

8. The battery of claim 1, wherein the aqueous electrolyte has an acid or neutral pH.

9. (canceled)

10. The battery of claim 1, wherein the anode comprises a pasted porous Zn electrode, a Zn metal foil electrode, a Zn mesh electrode, or a perforated Zn metal foil electrode.

11. The battery of claim 1, wherein the cathode comprises a manganese dioxide electrode, a nickel oxyhydroxide electrode, a silver oxide electrode, or an air electrode.

12. The battery of claim 1, further comprising: a separator disposed between the anode and the cathode, wherein the separator comprises films fabricated from nylon, polyester, polyethylene, polypropylene, poly(tetrafluoroethylene) (PTFE), poly(vinyl chloride) (PVC), polyvinyl alcohol, cellulose, or combinations thereof.

13. The battery of claim 1, wherein the aqueous electrolyte comprises a gassing inhibitor, and wherein the gassing inhibitor comprises indium hydroxide, indium, indium oxide, bismuth oxide, bismuth, carboxymethyl cellulose, polyethylene glycol, zinc oxide, cetyltrimethylammonium bromide, or combinations thereof.

14. The battery of claim 1, wherein the battery is prismatic or cylindrical.

15. A battery comprising:
an anode;
a cathode;
a catholyte in contact with the cathode and not the anode; and
an anolyte disposed in contact with the anode and not the cathode, wherein the anolyte comprises an inert hydrophilic polymer matrix impregnated with an aqueous electrolyte.

16. The battery of claim 15, wherein the hydrophilic polymer matrix comprises a polar vinyl monomer, an initiator, and a cross-linker.

17. The battery of claim 16, wherein the polar vinyl monomer is selected from the group consisting of: acrylic acid, vinyl acetate, acrylate esters, vinyl isocyanate, acrylonitrile, and combinations thereof.

18. The battery of claim 16, wherein the polar vinyl monomer is present in the amount in a range of 5 wt. % to 50 wt. %, the initiator is present in the amount in a range of 0.001 wt. % to 0.1 wt. %, and the cross-linker is present in an amount in a range of 0.001 wt. % to 5 wt. %.

19. The battery of claim 15, wherein the aqueous electrolyte comprises a basic solution and additives, and wherein the base solution comprises sodium hydroxide, potassium hydroxide, lithium hydroxide, ammonium hydroxide, or any combination thereof.

20. (canceled)

21. (canceled)

22. The battery of claim 15, wherein the aqueous electrolyte has an acid or neutral pH.

23. (canceled)

24. The battery of claim 15, wherein the anode comprises a pasted porous Zn electrode, a Zn metal foil electrode, a Zn mesh electrode, or a perforated Zn metal foil electrode.

25. The battery of claim 15, wherein the cathode comprises a manganese dioxide electrode, a nickel oxyhydroxide electrode, a silver oxide electrode, or an air electrode.

26. The battery of claim 15, further comprising: a separator disposed between the anode and the cathode, wherein the separator comprises films fabricated from nylon, polyester, polyethylene, polypropylene, poly(tetrafluoroethylene) (PTFE), poly(vinyl chloride) (PVC), polyvinyl alcohol, cellulose or combinations thereof.

27. The battery of claim 15, wherein the aqueous electrolyte comprises gassing inhibitor, and wherein the gassing inhibitor comprises indium hydroxide, indium, indium oxide, bismuth oxide, bismuth, carboxymethyl cellulose, polyethylene glycol, zinc oxide, cetyltrimethylammonium bromide, or combinations thereof.

28. The battery of claim 15, wherein the battery is prismatic or cylindrical.

29. The battery of claim 15, wherein the catholyte comprises a second inert hydrophilic polymer matrix impregnated with a second aqueous electrolyte.

30. The battery of claim 15, wherein the catholyte and the anolyte have different pH values.

31. A method for fabricating a battery, the method comprising:
forming a cathode;
forming an anode comprising zinc;
forming and disposing a gelled electrolyte between the anode and the cathode, wherein the gelled electrolyte comprises an inert hydrophilic polymer matrix impregnated with an aqueous electrolyte; and
enclosing the cathode, the anode, and the gelled electrolyte to form a battery.

32. The method of claim 31, wherein forming and disposing the gelled electrolyte between the anode and the cathode comprises:
polymerizing the aqueous electrolyte to form a gelled electrolyte sheet; and
disposing the gelled electrolyte sheet between the anode and the cathode within the battery.

33. The method of claim 31, wherein forming and disposing the gelled electrolyte between the anode and the cathode comprises:
enclosing the anode and the cathode within a battery housing;
injecting the aqueous electrolyte combined with a polymer monomer and initiator as a liquid into the battery housing;
polymerizing the aqueous electrolyte combined with the polymer monomer; and initiator to form the gelled electrolyte within the battery housing.

34. The method of claim 33, further comprising:
creating a vacuum within the battery housing while injecting the aqueous electrolyte combined with a polymer monomer and initiator as a liquid into the battery housing.

35. The method of claim 31, further comprising:
soaking the anode in the aqueous electrolyte prior to enclosing the cathode, the anode, and the gelled electrolyte to form the battery.

36. The method of claim 31, further comprising:
enclosing the anode and the cathode within the battery housing;
injecting a first volume of the aqueous electrolyte into the battery housing;
soaking the anode and the cathode within the battery housing;
removing at least a portion of the first volume of the aqueous electrolyte from the battery housing;
injecting a second volume of the aqueous electrolyte combined with a polymer monomer and initiator as a liquid into the battery housing;
polymerizing the second volume of the aqueous electrolyte combined with the polymer monomer and initiator to form the gelled electrolyte within the battery housing.

37. The method of claim 31, wherein the battery is prismatic or cylindrical.

38. The method of claim 31, further comprising: disposing 0 to 5 layers of a separator between the anode and the cathode.
